(19) United States
(12) Patent Application Publication
(10) Pub. No.: US 2026/0110349 A1
(43) Pub. Date: Apr. 23, 2026

(54) MODULAR MULTI-SPEED PLANETARY TRANSMISSION WITH SHARED FLOATING CARRIER AND SELECTIVE BRAKE ENGAGEMENT

(71) Applicant: Zander Beaver, Mount Pleasant Mills, PA (US)

(72) Inventor: Zander Beaver, Mount Pleasant Mills, PA (US)

(21) Appl. No.: 19/212,143

(22) Filed: May 19, 2025

Related U.S. Application Data
(60) Provisional application No. 63/709,413, filed on Oct. 19, 2024.

(51) Int. Cl. F16H 3/66

(52) U.S. Cl. CPC F16H 3/663; F16H 2200/202

(57) ABSTRACT

This modular planetary transmission uses a single shared floating carrier to house both input and output planetary gearsets. The input and output sun-gear-shafts are mechanically isolated, and torque is transferred solely through internal gear interactions within the shared carrier. Gear ratios are established by selectively braking one input and one output selector sun-gear-shaft using case-mounted braking elements. Torque flows from the input sun-gear-shaft through the input gearset, rotating the carrier, which in turn drives the output gearset and the output sun-gear-shaft. The resulting input-to-output ratio is defined by the product of the input-to-carrier and carrier-to-output gear ratios. Unique gear ratios are achieved through a two-brake control matrix formed by different combinations of braked selector shafts. The architecture enables fast, full-power shifts without rotating clutches, allows high gear counts, improves packaging efficiency, reduces complexity, and increases durability—making it suitable for high-performance or compact driveline applications.

### CROSS-REFERENCE TO RELATED APPLICATIONS This application claims the benefit of the following U.S. Provisional Patent Applications under 35 U.S. C. § 119(e):

U.S. Provisional Application No. 63/682,220, filed Aug. 12, 2024;
U.S. Provisional Application No. 63/694,817, filed Sep. 14, 2024;
U.S. Provisional Application No. 63/704,169, filed Oct. 7, 2024;
U.S. Provisional Application No. 63/705,025, filed Oct. 8, 2024; and
U.S. Provisional Application No. 63/709,413, filed Oct. 19, 2024.
   The entire contents of each of the above-referenced applications are incorporated herein by reference.

### FIELD OF THE INVENTION

The invention relates to modular, brake-actuated planetary transmissions employing a single shared floating carrier (102) that links two independent planetary gearsets—an input gearset (104) and an output gearset (118)—to produce multiple gear ratios without the use of ring gears, rotating clutches, or traditional torque paths. It is particularly suited for high-density, high-performance drivetrains in automotive and industrial applications where compact packaging, rapid shifting, and extreme durability are required.

### BACKGROUND OF THE INVENTION

Conventional automatic and manual transmissions typically rely on rotating clutches, multiple planetary carriers, or fixed meshing between input and output stages. These systems often involve complex hydraulic control circuits, rotating friction clutches, limited gear ratio flexibility, and packaging inefficiencies.

Existing designs with multiple planetary stages either stack carriers sequentially or share torque paths through rigidly connected components, limiting both configurability and functional modularity. They also frequently require ring gears or sprag clutches to define directional behavior and torque flow.

There exists a need for a transmission architecture that provides multiple gear ratios—including overdrive, underdrive, forward, and reverse—using a simpler, more modular configuration. An ideal solution would support a wide range of ratio options and high gear counts within a single architecture, while significantly reducing complexity, component count, and packaging constraints. Such a design would eliminate the need for rotating clutches, sprags, and compounded planetary carriers, and allow all gear ratios to be achieved exclusively through selective braking of components.

### OBJECT OF THE INVENTION

An object of the present invention is to provide a multi-speed planetary transmission that significantly reduces complexity, component count, cost, and rotating mass by eliminating traditional rotating multi-plate clutch packs, sprags, ring gears, and complex fluid passages. The invention enables gear changes using only non-rotating, case-mounted brakes, allowing the use of oversized friction elements with minimal packaging penalty and improved reliability. It further permits full-power, non-sequential upshifts and downshifts without torque interruption or reduction due to the absence of fragile, torque-sensitive components. A further object is to achieve high gear counts—including overdrive and reverse—in an ultra-compact form factor.

The architecture supports modular scalability of gear ratios without altering the core layout or introducing new torque paths.

### SUMMARY OF THE INVENTION

A planetary transmission architecture utilizing a single shared planet carrier (102) that contains both an independent input gearset (104) and an independent output gearset (118). The carrier (102) is neither directly driven nor directly connected to the input sun-gear-shaft (106) or the output sun-gear-shaft (120), but instead functions as a floating mechanical intermediary—that is, it transfers torque from the input gearset (104) to the output gearset (118) solely through internal gear reactions, without being mechanically coupled to either shaft during normal operation, while remaining fully supported by the carrier support (136) within the transmission housing.

The input gearset (104) and output gearset (118) are functionally distinct and do not directly mesh with one another, but are dynamically coupled via the motion and torque interaction of the common carrier (102). All torque transfer between the input and output sides occurs exclusively through the carrier (102), which transmits power by internal planet-gear-shaft rotation and orbital motion, rather than any direct coupling or shared meshing between the input gearset (104) and output gearset (118).

The input sun-gear-shaft (106) engages a set of input planet-gear-shafts (116) mounted within the carrier (102). Each of these planet-gear-shafts (116) carries multiple rigidly affixed toothed gears, forming an integrated shaft assembly. One of the affixed gears on each shaft engages the central input sun-gear-shaft (106), while the remaining gears engage their respective input selector sun-gear-shafts shaft (108, 110, 112, or 114), which are concentrically nested and rotatable about the same common axis. These selector sun-gear-shafts are journaled and free to rotate when not engaged. When an input case-mounted braking element and actuation mechanism (700) is applied to one of these input selector sun-gear-shafts (108, 110, 112, or 114), it locks to the case, forming a reaction path. This causes the planet gears on the input planet-gear-shafts (116) to orbit the locked selector sun-gear-shaft, thereby rotating the entire carrier (102) at a ratio determined by the interaction between the input sun-gear-shaft (106) and the selected locked selector sun-gear-shaft (108, 110, 112, or 114).

The carrier (102), now rotating, transmits this torque directly to the output planetary gearset (118), housed in the same common carrier (102) body. This output gearset (118) contains a second set of output planet-gear-shafts (132), each also supporting multiple rigidly affixed toothed gears: one engaging the output sun-gear-shaft (120) and the others engaging their respective output selector sun-gear-shafts (122, 124, 126, or 128), which are similarly nested concentrically and rotatable about a shared axis. When an output case-mounted braking element and actuation mechanism (700) is applied to one of these output selector sun-gear-shafts, it locks to the case, providing a reaction element. The rotating carrier (102) then drives the planet gears on the output planet-gear-shafts (132) to orbit the locked selector sun-gear-shaft, producing output sun-gear-shaft (120) rotation at a ratio defined by the selected carrier-to-output interaction.

This input-to-carrier ratio multiplied by the carrier-to-output ratio yields the final input-to-output ratio.

All gear interaction is mechanical and fixed based on known tooth counts of the involved sun-gear-shafts and planet-gear-shaft gears. All selector sun-gear-shafts rotate unless they are locked to the case via case-mounted braking elements and actuation mechanisms (700). To form an input-to-output ratio, only one input selector sun-gear-shaft (108, 110, 112, or 114) and one output selector sun-gear-shaft (122, 124, 126, or 128) are locked to the case via case-mounted braking elements and actuation mechanisms (700) at a given time. These form a pair of reaction elements that define the final input-to-output ratio.

In this architecture, gear ratios are typically established by selectively engaging two brakes—one on the input gearset (104) and one on the output gearset (118). Engaging fewer than two brakes at a given time results in a neutral condition. Engaging more than two brakes simultaneously causes full lock-up of the planetary system, resulting in a transbrake or mechanical lock state.

The architecture inherently supports underdrive, overdrive, and both forward and reverse outputs—all within a single shared planetary carrier (102)—based solely on the relative diameters of the involved sun-gear-shafts. The final output direction and ratio are fully defined by the locked input selector sun-gear-shaft (108, 110, 112, or 114) and the locked output selector sun-gear-shaft (122, 124, 126, or 128), eliminating the need for additional reverse gearsets, such as separate reverse planetary stages, idler gears, or other reverse specific gearsets. An optional reverse selector sun-gear-shaft (128), when present, is housed within the same planetary output gearset (118) and does not constitute a separate reverse geartrain.

### Input Behavior

When the input sun-gear-shaft (106) is smaller than the locked input selector sun-gear-shaft (108, 110, 112, or 114), the carrier (102) rotates in the opposite direction of the input shaft.
When the input sun-gear-shaft (106) is larger than the locked input selector sun-gear-shaft (108, 110, 112, or 114), the carrier (102) rotates in the same direction as the input shaft.

### Output Behavior

When the output sun-gear-shaft (120) is smaller than the locked output selector sun-gear-shaft (122, 124, 126, or 128), the output sun-gear-shaft (120) rotates in the opposite direction of the carrier (102).
When the output sun-gear-shaft (120) is larger than the locked output selector sun-gear-shaft (122, 124, 126, or 128), the output sun-gear-shaft (120) rotates in the same direction as the carrier (102).

This architecture is designed to function without:
Any rotating multi-plate clutches
Ring gears for torque transfer or directional reversal
Rotating fluid passages
Sprags or overrunning clutches
Multiple staged carriers

The result is a compact, modular, and highly configurable planetary transmission allowing high gear counts and a wide range of available ratios.

### REVERSE GEAR IMPLEMENTATION

In one configuration, a dedicated reverse selector sun-gear-shaft (128) may be included in the output gearset (118). This reverse-specific output selector sun-gear-shaft (128) is dimensioned to produce the desired reverse output direction and gear ratio when engaged via a case-mounted braking element and actuation mechanism (700). This method enables reverse gear selection using the same two-brake normal operation control logic, all within the same shared carrier (102) and output gearset (118).

Alternatively, the input sun-gear-shaft (106) is selectively mechanically coupled to either an input selector sun-gear-shaft (108, 110, 112, or 114), or directly to the shared carrier (102). This configuration eliminates relative motion within the input planetary gearset (104), effectively creating a 1:1 input-to-carrier drive condition. Reverse rotation of the output sun-gear-shaft (120) relative to the input sun-gear-shaft (106) is then achieved by locking an output selector sun-gear-shaft (122, 124, 126, or 128) to the case, thereby establishing a reverse input-to-output ratio.

In another configuration, the output sun-gear-shaft (120) is selectively mechanically coupled to either an output selector sun-gear-shaft (122, 124, 126, or 128), or directly to the shared carrier (102). This eliminates relative motion within the output gearset (118), effectively creating a 1:1 carrier-to-output drive condition. Reverse rotation of the output sun-gear-shaft (120) relative to the input sun-gear-shaft (106) is then established by locking an input selector sun-gear-shaft (108, 110, 112, or 114) to the case, thereby establishing a reverse input-to-output ratio.

In all cases, reverse torque transfer is mediated exclusively through the shared carrier (102), which functions as the sole mechanical intermediary between the input sun-gear-shaft (106) and the output sun-gear-shaft (120). These configurations enable full-power reverse operation without the need for auxiliary gearsets, preserving packaging efficiency, robustness, and the core simplicity of the design.

### ADVANTAGES

Due to the unique planetary arrangement, the system maintains consistent relative speeds across all components during shifts. The unlocked selector sun-gear-shafts (108, 110, 112, 114, 122, 124, 126, 128) rotate at a fraction of the input RPM, reducing clutch loading and minimizing shock during engagement. Because these unlocked selector sun-gear-shafts (108, 110, 112, 114, 122, 124, 126, 128) are not part of the active torque path, they operate at low rotational speeds. This reduces internal drag, extends component life, lowers bearing stress, enables ultrafast shifting without torque reduction, significantly reduces shift shock, enhances smoothness, supports gear skipping—both up and down the ratio range under full load—and improves overall system efficiency. Together, these characteristics result in lower internal losses, reduced mechanical shock, and improved NVH. The two-brake control strategy does not rely on fragile components, as seen in modern transmissions that require torque cut and sensitive clutch coordination during each shift. This architecture enables full-power shifts with no torque interruption, delivering faster, more consistent, and easier-to-tune gear changes without compromising reliability or performance.

### MODULAR ARCHITECTURE AND SCALABILITY

A key feature of this planetary transmission architecture is its inherent modularity, which allows a designer to scale the number of available forward gear ratios without modifying the fundamental layout or requiring additional gearsets or carriers. Gear ratios are formed through the interaction of two distinct stages—an input gearset (104) and an output gearset (118)—each independently defining a portion of the final drive ratio. Specifically, the final drive ratio is calculated as:

$$Final Ratio = ( Input - to - Carrier Ratio ) \times ( Carrier - to - Output Ratio )$$

During normal operation, each gear ratio is achieved by engaging exactly one input selector sun-gear-shaft (108, 110, 112, or 114) and one output selector sun-gear-shaft (122, 124, 126, or 128) using case-mounted braking elements and actuation mechanisms (700). By combining each input gearset (104) combination with each output gearset (118) combination, a matrix of possible gear ratios is formed. For example:
A system with 2 input selector sun-gear-shafts and 3 output selector sun-gear-shafts yields 6 unique gear ratios (2×3)
A system with 3 input selector sun-gear-shafts and 3 output selector sun-gear-shafts yields 9 gear ratios (3×3)
A system with 3 input selector sun-gear-shafts and 4 output selector sun-gear-shafts yields 12 gear ratios (3×4)
A system with 4 input selector sun-gear-shafts (108, 110, 112, 114) and 4 output selector sun-gear-shafts (122, 124, 126, 128) yields 16 gear ratios (4×4)

### RATIO RANGE FLEXIBILITY

Because the final input-to-output ratio is the product of an input-to-carrier ratio and a carrier-to-output ratio, the transmission architecture inherently supports a wide range of total gear ratios without requiring changes to the core structural layout or operating logic. The system can achieve deep underdrive, high overdrive, wide-range ratio sets, mid-range ratio sets, and tightly spaced ratio sets, depending on the specific combination of selector sun-gear-shafts (108, 110, 112, 114, 122, 124, 126, 128) and their respective diameters. For example, a close-ratio 12-speed automotive configuration (900) or a wide-ratio 12-speed commercial configuration (800) can be achieved within the same core architecture, layout, and two-brake control matrix. This allows the same shared carrier (102) and two-brake control logic to be adapted across diverse use cases—including passenger vehicle, motorsport, commercial, and high-efficiency applications. While specific gear ratios or gear counts may require different component dimensions, the core architecture, layout, and two-brake control matrix remain unchanged. The system supports both evenly spaced and custom-spaced gear steps, and scales easily from compact 6-speed configurations to 16-speed or higher variants without altering the fundamental architecture. This level of ratio flexibility, modularity, and tuning capability within a fixed design framework is not found in conventional transmission systems.

### LAUNCH CAPABILITY WITHOUT EXTERNAL CLUTCH OR TORQUE CONVERTER

In contrast to conventional transmissions such as automatic and dual-clutch systems (DCTs), which rely on rotating wet clutches or torque converters for launch, the present invention enables vehicle launch using the same case-mounted braking elements and actuation mechanisms (700) employed for gear selection. By modulating one of these existing case-mounted braking elements and actuation mechanisms (700) elements, initial torque transfer is achieved without the need for any rotating clutch pack, input shaft clutch, or fluid coupling. This eliminates rotating hydraulic passages, reduces packaging complexity, avoids leak-prone rotating seals, and allows dual use of internal brake components for both launch and ratio control—enhancing reliability, reducing cost, and improving thermal and mechanical efficiency under high-load conditions.

### BRIEF DESCRIPTION OF THE DRAWINGS

FIG. 1—CROSS-SECTIONAL VIEW OF COMPLETE TRANSMISSION CARRIER AND GEARSET ASSEMBLY

Illustrates the complete transmission geartrain architecture, including input and output gearsets, shared carrier, selector sun-gear-shafts, and planetary shafts.
102—Shared carrier
104—Input gearset
106—Input sun-gear-shaft
108—Input selector sun-gear-shaft 1
110—Input selector sun-gear-shaft 2
112—Input selector sun-gear-shaft 3
114—Input selector sun-gear-shaft 4
116—Input planet-gear-shaft
118—Output gearset
120—Output sun-gear-shaft
122—Output selector sun-gear-shaft 1
124—Output selector sun-gear-shaft 2
126—Output selector sun-gear-shaft 3
128—Output selector sun-gear-shaft 4 (reverse)
132—Output planet-gear-shaft
134—Planet shaft end support bearing
136—Carrier support

FIG. 2—SUN-GEAR-SHAFTS ISOLATED
104—Input gearset
106—Input sun-gear-shaft
108—Input selector sun-gear-shaft 1
110—Input selector sun-gear-shaft 2
112—Input selector sun-gear-shaft 3
114—Input selector sun-gear-shaft 4
118—Output gearset
120—Output sun-gear-shaft
122—Output selector sun-gear-shaft 1
124—Output selector sun-gear-shaft 2
126—Output selector sun-gear-shaft 3
128—Output selector sun-gear-shaft 4 (reverse)

FIG. 3—INPUT GEARSET ASSEMBLY ALONE

Shows the input components in isolation for clarity of internal torque path and selector layout. (input-to-carrier)
104—Input gearset
106—Input sun-gear-shaft
108—Input selector sun-gear-shaft 1
110—Input selector sun-gear-shaft 2
112—Input selector sun-gear-shaft 3
114—Input selector sun-gear-shaft 4
116—Input planet-gear-shaft
134—Planet shaft end support bearing

FIG. 4—OUTPUT GEARSET ASSEMBLY

Shows the output components in isolation for clarity of internal torque path and selector layout. (carrier-to-output)
118—Output gearset
120—Output sun-gear-shaft
122—Output selector sun-gear-shaft 1
124—Output selector sun-gear-shaft 2
126—Output selector sun-gear-shaft 3
128—Output selector sun-gear-shaft 4 (reverse)
132—Output planet-gear-shaft
134—Planet shaft end support bearing

FIG. 5—SHARED CARRIER ASSEMBLY

Depicts the shared floating carrier without internal components, highlighting mounting structure and shaft passages.
102—Shared carrier
136—Carrier support

FIG. 6—PLANET SHAFTS WITH MULTIPLE RIGIDLY AFFIXED GEARS

Details both input and output planet-gear-shafts showing how they carry multiple rigidly affixed gears interacting with selector sun-gear-shafts.
116—Input planet-gear-shaft
132—Output planet-gear-shaft
134—Planet shaft end support bearing

FIG. 7—CASE-MOUNTED BRAKING ELEMENTS AND ACTUATION MECHANISMS
710—Brake: A drum-style brake with a band and servo mechanism. The drum rotates freely until the band is actuated; the brake is mounted to or within the case.
124—Output selector sun-gear-shaft 2: A selector sun-gear-shaft rigidly connected to the drum. When the brake is applied, this gear is locked to the case to serve as a reaction element.

FIG. 8—GEAR RATIO TABLE: COMMERCIAL 12-SPEED WIDE-RATIO CONFIGURATION

This figure illustrates a 16-speed planetary transmission configuration comprising 12 forward gears and 4 reverse gears, designed for commercial and heavy-duty applications. The system delivers a broad overall ratio spread ranging from 14.62:1 to 0.73:1, with consistent intermediate steps of approximately 23.5% to 24.5%. This enables both deep underdrive for heavy load conditions and efficient overdrive for cruising. The inclusion of four reverse gears demonstrates the architecture's ability to support multiple reverse ratios using the same two-brake logic matrix. All 16 ratios are achieved without modifying the core shared-carrier layout, highlighting the modularity and scalability of the system.

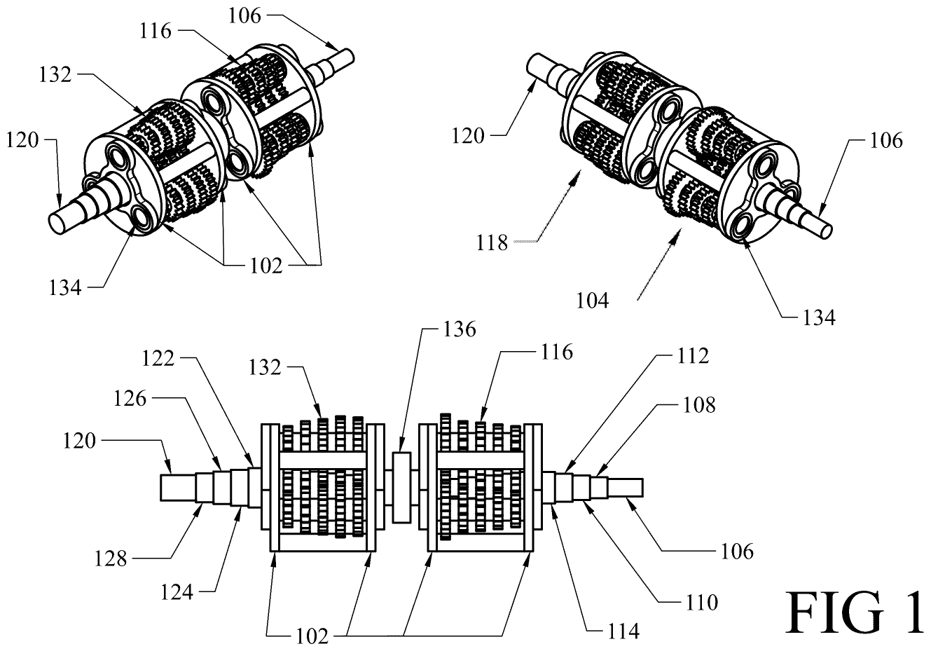

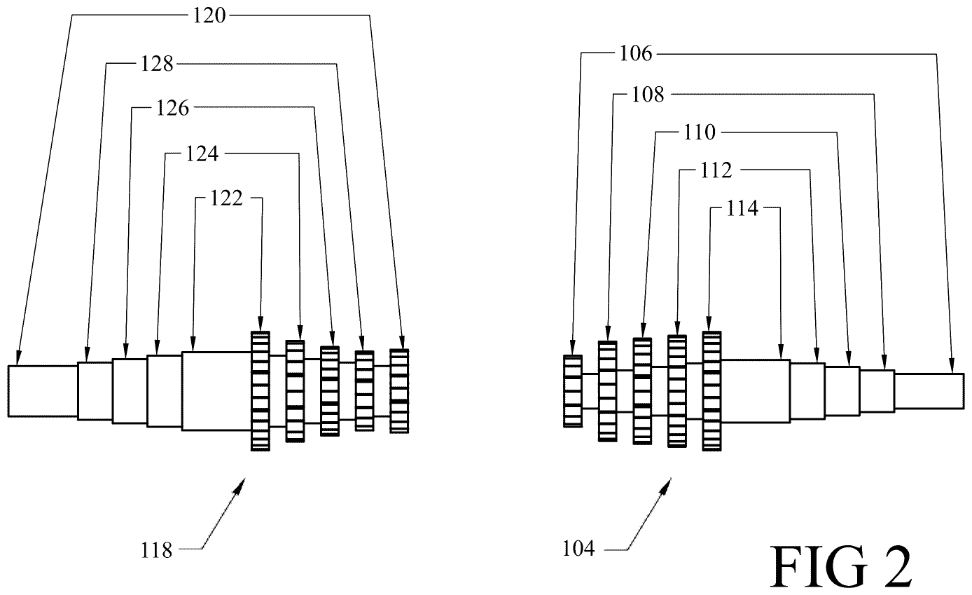

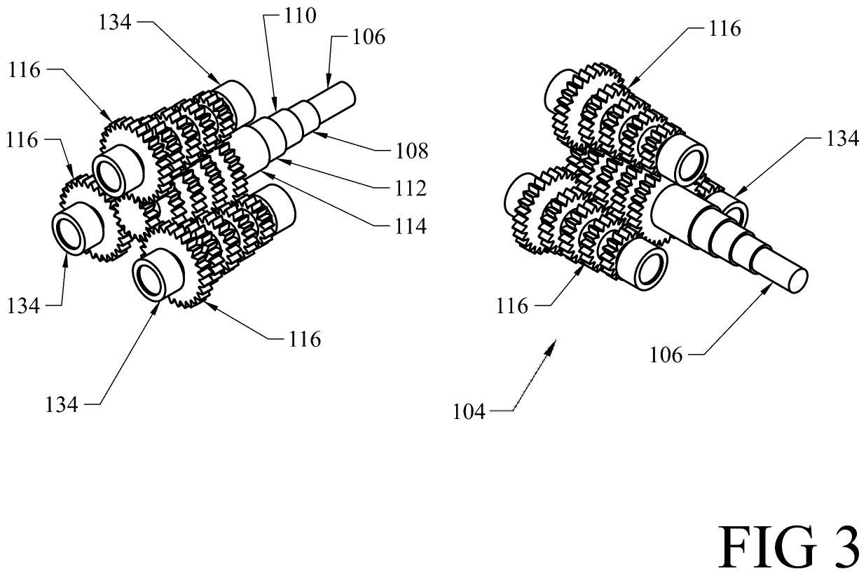

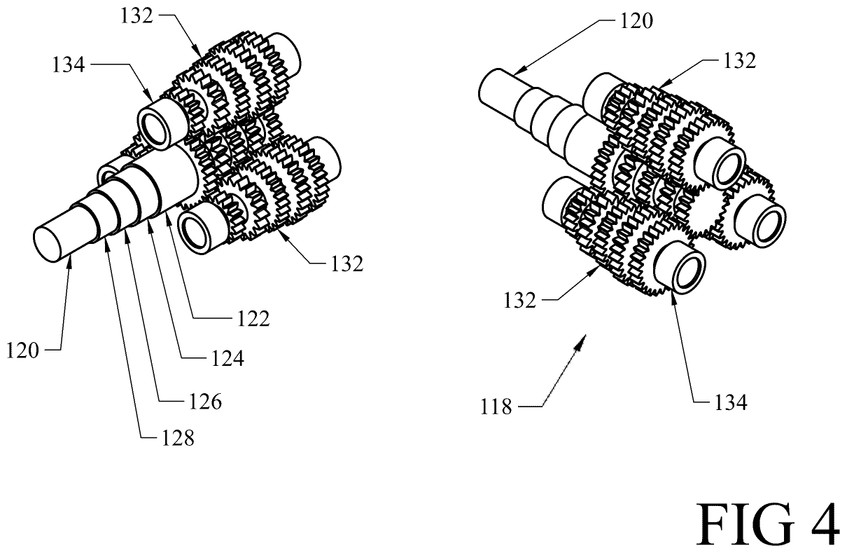

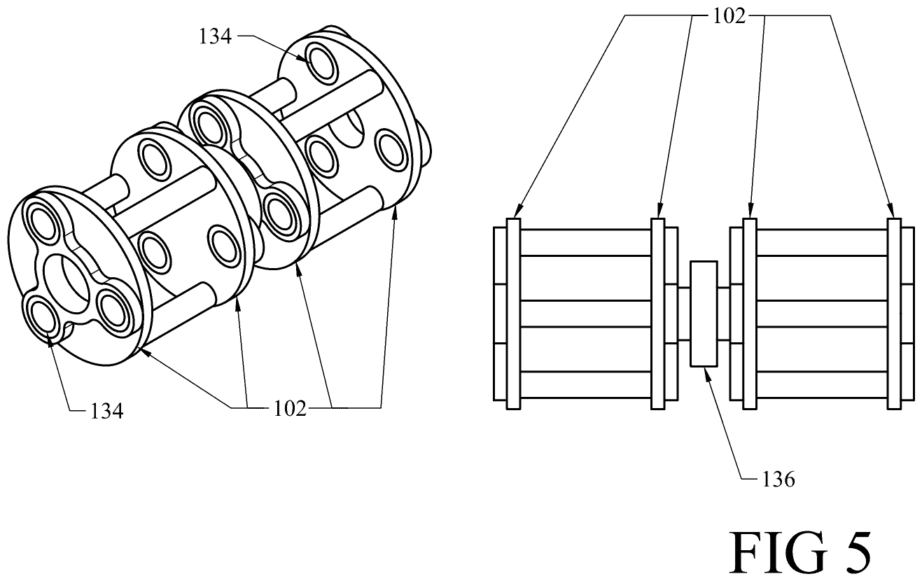

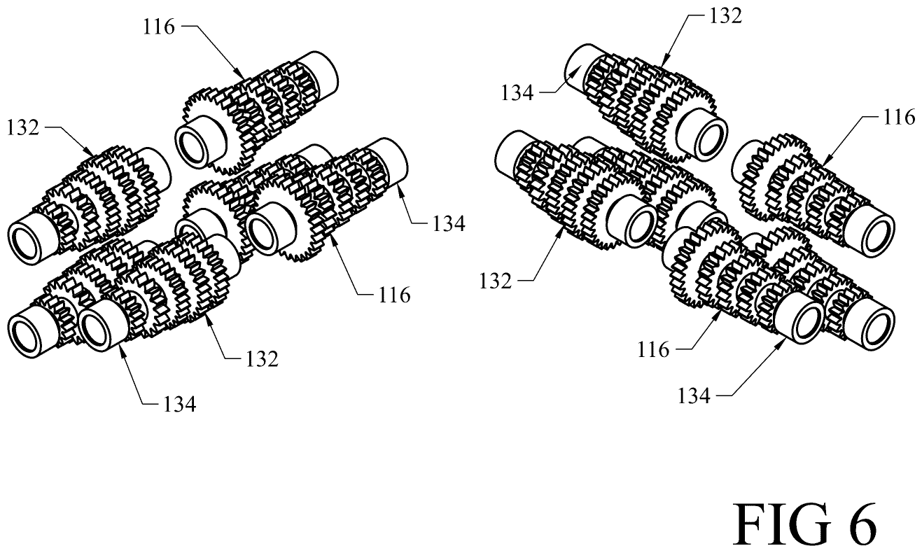

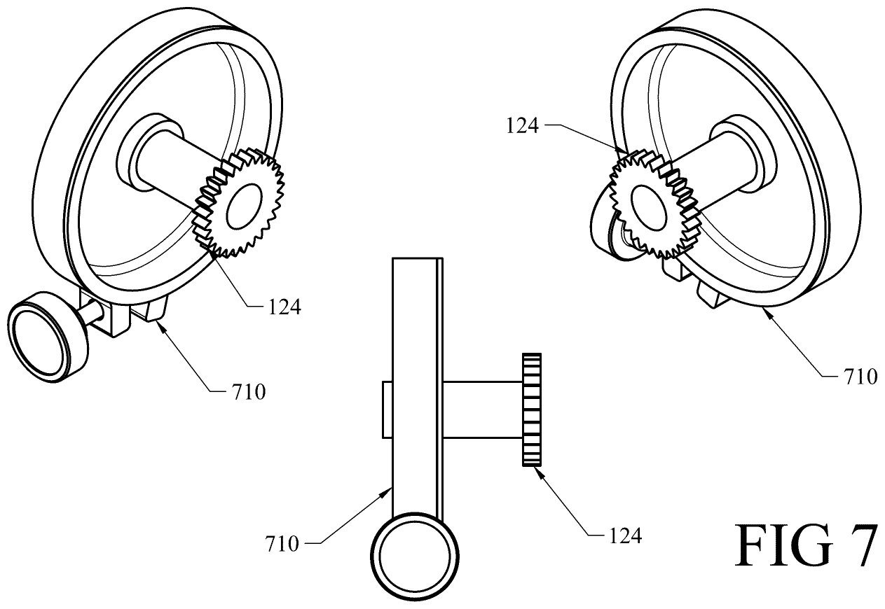

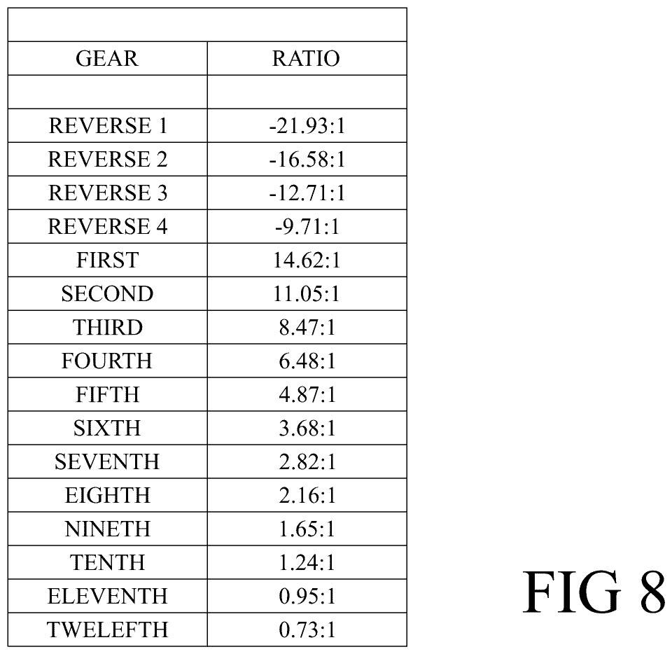

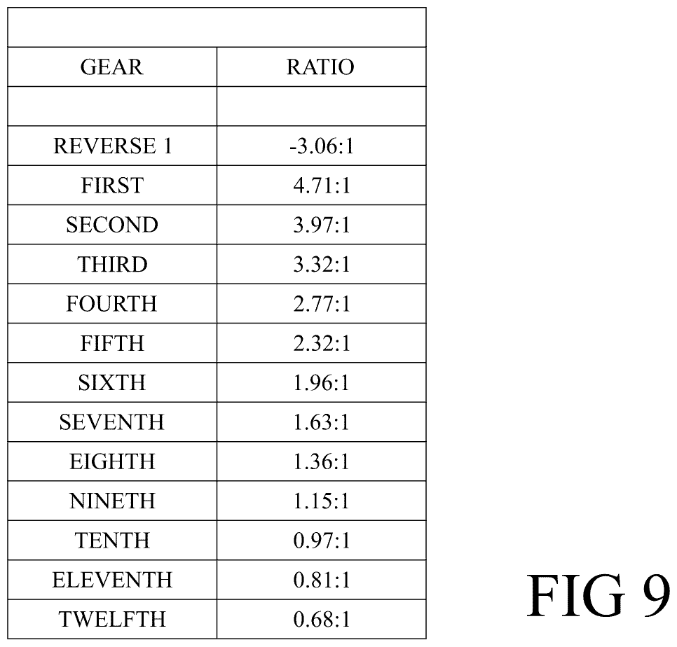

The configuration shown in FIGS. 1-7, using four input selector sun-gear-shafts (108, 110, 112, 114) and four output selector sun-gear-shafts (122, 124, 126, 128), corresponds to the 16 gear ratios detailed in FIG. 8.

FIG. 9—GEAR RATIO TABLE: AUTOMOTIVE 12-SPEED CLOSE-RATIO CONFIGURATION

This figure illustrates a 12-speed planetary transmission configuration optimized for high-performance automotive use. Forward gear ratios range from 4.71:1 to 0.68:1, with consistent intermediate steps (˜15-16.5% spacing) to support smooth and responsive acceleration. A single usable reverse gear is provided using a nonstandard coupling configuration outside the normal two-brake matrix, demonstrating the architecture's flexibility to support reverse functionality even when all selector sun-gear-shafts are dedicated to forward ratios. The configuration maintains the same core shared-carrier layout as wide-range variants.

Note: The drawings and figures are intended for conceptual illustration only. They prioritize visual clarity and teaching of operational principles over physical scale, packaging constraints, or production-ready geometry. Actual implementation may require engineering adaptations to optimize manufacturability, performance, and compactness.

### DETAILED DESCRIPTION OF THE INVENTION

### Definitions

As used herein, the following terms shall have the meanings set forth below unless explicitly stated otherwise. These definitions are provided for clarity and are not intended to limit the scope of the invention.

### Carrier (102):

A rotating mechanical body that supports multiple planet-gear-shafts (116, 132) and provides torque transfer between the input gearset (104) and output gearset (118).

The carrier (102) may be formed from one or more structural components or subassemblies that are rigidly joined together to function as a single, unified rotating member, such that all planet-gear-shafts (116, 132) and associated components rotate as a single body. during normal operation the carrier (102) is not directly driven by the input sun-gear-shaft (106) or output sun-gear-shaft (120) and acts as a floating mechanical intermediary within the planetary system. It houses the planet shaft end support bearings (134) for the planet-gear-shafts (116, 132) and may also be structurally supported both radially and/or axially by the carrier support (136) mounted to the transmission case via one or more bearings or bushings.

### Input Planet-Gear-Shaft (116):

A shaft mounted within the shared carrier (102), carrying multiple rigidly affixed toothed gears that engage the input sun-gear-shaft (106) and input selector sun-gear-shafts (108, 110, 112, 114) in the input gearset (104). These shafts rotate with the carrier (102) and facilitate both internal gear rotation and orbital motion within the planetary system. Typically, each input planet-gear-shaft (116) supports a number of rigidly affixed toothed gears corresponding to the total number of sun-gear-shafts in the input gearset (106, 108, 110, 112, 114). For example, in a configuration with one input sun-gear-shaft (106) and four input selector sun-gear-shafts (108, 110, 112, 114), each input planet-gear-shaft (116) would carry five rigidly affixed toothed gears.

### Output Planet-Gear-Shaft (132):

A shaft mounted within the shared carrier (102), carrying multiple rigidly affixed toothed gears that engage the output sun-gear-shaft (120) and output selector sun-gear-shafts (122, 124, 126, 128) in the output gearset (118). These shafts rotate with the carrier (102) and facilitate both internal gear rotation and orbital motion within the planetary system. Typically, each output planet-gear-shaft (132) supports a number of rigidly affixed toothed gears corresponding to the total number of sun-gear-shafts in the output gearset (120, 122, 124, 126, 128). For example, in a configuration with one output sun-gear-shaft (120) and four output selector sun-gear-shafts (122, 124, 126, 128), each output planet-gear-shaft (132) would carry five rigidly affixed toothed gears.

### Rigidly Affixed:

As used herein, “rigidly affixed” refers to a secure mechanical connection between a toothed gear and a shaft such that no relative rotational motion occurs under operational torque loads. This includes, but is not limited to, connections made via splines, press-fits, shrink-fits, welding, brazing, bonding, mechanical fasteners (e.g., pins, rivets), or monolithic (single-piece) construction. The defining characteristic is that the gear and shaft rotate as a single unit during normal operation without slippage or backlash.

### Input Selector Sun-Gear-Shaft (108, 110, 112, 114):

A sun-gear-shaft rotatably supported about the main transmission axis and concentrically nested with other sun-gear-shafts in the input gearset (104). Each input selector sun-gear-shaft may be selectively locked to the stationary transmission case by a dedicated case-mounted braking element and actuation mechanism (700), forming a reaction element. The selection of one input selector sun-gear-shaft determines the input-to-carrier ratio by controlling orbital motion of the input planet-gear-shafts (116).

### Output Selector Sun-Gear-Shaft (122, 124, 126, 128):

A sun-gear-shaft rotatably supported about the main transmission axis and concentrically nested with other sun-gear-shafts in the output gearset (118). Each output selector sun-gear-shaft may be selectively locked to the stationary transmission case by a dedicated case-mounted braking element and actuation mechanism (700), forming a reaction element. The selection of one output selector sun-gear-shaft determines the carrier-to-output ratio by controlling orbital motion of the output planet-gear-shafts (132).

### Input Sun-Gear-Shaft (106):

A shaft driven by a power source, such as an engine or motor, which drives the input sun-gear-shaft (106). This component initiates torque flow into the planetary system by engaging the input planet-gear-shafts (116).

### Output Sun-Gear-Shaft (120):

A shaft mechanically coupled to a driveline, axle, or downstream load. It receives torque from the planetary system as a result of the rotational interaction between the shared carrier (102), the output planet-gear-shafts (132), and the locked output selector sun-gear-shaft (122, 124, 126, 128). The output sun-gear-shaft (120) is driven by the orbital motion of the output planet-gear-shafts (132) as they react against the fixed selector sun-gear-shaft.

### Sun-Gear-Shaft:

As used herein, a “sun-gear-shaft” refers to a shaft having a toothed sun gear either integrally formed or rigidly affixed to it, such that the gear and shaft rotate together as a single unit. The sun gear is positioned to engage one or more planet gears within a planetary gearset, transmitting or receiving torque along the transmission axis. The sun-gear-shaft may be concentrically aligned with other nested shafts and supported for rotation within the transmission housing.

### Case-Mounted Braking Element and Actuation Mechanism (700):

A case-mounted braking element and actuation mechanism (700) affixed to the transmission housing, configured to selectively prevent rotation of a specific selector sun-gear-shaft (108, 110, 112, 114, 122, 124, 126, 128). Engagement of these case-mounted braking elements and actuation mechanisms (700) defines the active gear ratio by establishing reaction elements within the input gearset (104) and output gearset (118). The braking mechanism may be implemented using any suitable actuation method without limitation.

### Neutral Condition:

A system state in which torque flow is completely interrupted due to under-constraining the planetary system. This occurs when any of the following conditions are met:
Fewer than one input selector sun-gear-shaft (108, 110, 112, 114) in the input gearset (104) is braked.
Fewer than one output selector sun-gear-shaft (122, 124, 126, 128) in the output gearset (118) is braked.
Fewer than one input selector sun-gear-shaft (108, 110, 112, 114) in the input gearset (104) and fewer than one output selector sun-gear-shaft (122, 124, 126, 128) in the output gearset (118) are braked.
   In any of these cases, torque flow from the input sun-gear-shaft (106) to the output sun-gear-shaft (120) is fully interrupted. This state may be used intentionally for features such as neutral.

### Lock-Up/Transbrake Condition:

A system state in which torque flow is completely immobilized due to over-constraining the planetary system. This occurs when any of the following conditions are met:
More than one input selector sun-gear-shaft (108, 110, 112, 114) in the input gearset (104) is simultaneously braked, and at least one output selector sun-gear-shaft (122, 124, 126, 128) in the output gearset (118) is also braked.
More than one output selector sun-gear-shaft (122, 124, 126, 128) in the output gearset (118) is simultaneously braked, and at least one input selector sun-gear-shaft (108, 110, 112, 114) gear in the input gearset (104) is also braked.
More than one input selector sun-gear-shaft (108, 110, 112, 114) is braked in the input gearset (104) and more than one output selector sun-gear-shaft (122, 124, 126, 128) in the output gearset (118) is braked.
   In any of these cases, the shared carrier (102) and all connected components are fully constrained, resulting in zero internal or external rotation. This state may be used intentionally for features such as transbrake launch control, driveline hold, or mechanical lock.

### Final Gear Ratio:

The final input-to-output speed and torque relationship produced by the transmission system. It is defined by the product of the input-to-carrier and carrier-to-output gear ratios. Each final gear ratio is established by the selective engagement of exactly one input selector sun-gear-shaft (108, 110, 112, 114) and exactly one output selector sun-gear-shaft (122, 124, 126, 128).

### Input-To-Carrier Ratio:

The speed and torque relationship between the input sun-gear-shaft (106) and the shared carrier (102). This ratio is determined by the engagement of the input sun-gear-shaft (106) with the planet-gear-shafts (116), and the selection of a single locked input selector sun-gear-shaft (108, 110, 112, or 114) acting as a reaction element.

### Carrier-To-Output Ratio:

The speed and torque relationship between the shared carrier (102) and the output sun-gear-shaft (120). This ratio is defined by the engagement between the carrier-mounted (102) output planet-gear-shafts (132) and a single locked output selector sun-gear-shaft (122, 124, 126, or 128) acting as a reaction element.

### Floating Mechanical Intermediary:

As used herein, “floating” refers to the carrier's (102) functional role as an intermediary torque-transfer element that is not mechanically coupled to either the input sun-gear-shaft (106) or the output sun-gear-shaft (120) during normal operation. The term does not imply a lack of physical support or spatial constraint. The carrier (102) may be fully supported radially and/or axially by one or more structural elements such as center bearings, end bearings, bushings, or similar components used to form a carrier support (136), and may be located or retained within the transmission housing. The floating designation describes the absence of a direct mechanical drive or reaction path between the carrier (102) and/or the input sun-gear-shaft (106) and/or the output sun-gear-shaft (120), not its mounting condition.

### Normal Operation:

The standard operating mode of the transmission in which a gear ratio is established exclusively by the selective engagement of exactly one input selector sun-gear-shaft (108, 110, 112, or 114) and exactly one output selector sun-gear-shaft (122, 124, 126, or 128), each locked to the case via a dedicated case-mounted braking element and actuation mechanism (700). During normal operation, all torque transfer between the input sun-gear-shaft (106) and output sun-gear-shaft (120) occurs through the shared carrier (102) and the internal planetary gear interactions, with no direct mechanical coupling of the input (106) and/or output sun-gear-shaft (120) and/or shared carrier (102).

### Outside the Normal Two-Brake Control Scheme:

Refers to operational modes of the transmission in which torque transfer or gear selection occurs without the exclusive engagement of exactly one input selector sun-gear-shaft (108, 110, 112, or 114) and exactly one output selector sun-gear-shaft (122, 124, 126, or 128) via case-mounted braking elements and actuation mechanisms (700). This includes configurations where mechanical coupling of shafts replaces one of the brake-defined reaction paths, enabling alternative functionality such as reverse gear engagement beyond the standard two-brake-based logic.

### Selectively Mechanically Coupled:

A temporary or controllable mechanical connection established between two rotating components—such as a shaft and a gear—without requiring continuous or permanent engagement. The coupling may be achieved by any suitable mechanical means, including but not limited to: dog clutches, spline collars, sliding gear interfaces, cone clutches, or friction clutches. This connection is selectively engaged under defined operating conditions to enable or disable torque transfer or relative motion between components, typically to support non-standard torque paths, reverse operation, or auxiliary modes outside the primary brake-based control logic.

### Two-Brake Control Matrix:

A control logic scheme in which exactly two case-mounted braking elements and actuation mechanisms (700)—one assigned to an input selector sun-gear-shaft (108, 110, 112, 114) and one to an output selector sun-gear-shaft (122, 124, 126, 128)—are engaged at any given time to define a gear ratio. Each unique combination of a locked input selector sun-gear-shaft (108, 110, 112, 114) and a locked output selector sun-gear-shaft (122, 124, 126, 128) forms a distinct torque path and defines a unique gear ratio through internal planetary interaction via the shared carrier (102).

### Reaction Element:

A non-rotating selector sun-gear-shaft (108, 110, 112, 114, 122, 124, 126, 128) that is locked to the stationary transmission case to provide a fixed predetermined ratio. Engagement of a reaction element redirects planetary motion and establishes torque multiplication or reduction by controlling orbital motion within the gearset (104, 118).

### Separate Reverse Gearset:

Refers exclusively to additional gear stages or subsystems—such as idler geartrains, standalone reverse planetary sets, or countershaft-based modules—that are added solely for the purpose of producing reverse output direction. The term explicitly excludes an optional reverse selector sun-gear-shaft (128) housed within the existing output gearset (118), which operates within the same carrier (102) structure and does not constitute a separate geartrain.

### Overview of Transmission Architecture

The transmission architecture comprises a common carrier (102) that houses both the input gearset (104) and output gearset (118). The input shaft and output shaft are mechanically isolated and are not directly connected to each other or to the shared carrier (102). Instead, all torque transmission between the input gearset (104) and output gearset (118) occurs dynamically through the shared carrier (102). Although the carrier (102) is described as “floating,” this refers strictly to its functional decoupling from the input sun-gear-shaft (106) and output sun-gear-shaft (120). The carrier (102) is mechanically supported within the transmission housing using bearings or bushings within the structural carrier support (136), and is radially and axially constrained as required by the design. Its motion and alignment are therefore fully controlled even as it functions independently of direct shaft coupling.

On the input side, the input sun-gear-shaft (106) engages a set of input planet-gear-shafts (116), each of which supports multiple rigidly affixed toothed gears. These input planet-gear-shafts (116) are mounted within the shared carrier (102) and rotate with it. One of the affixed gears on each shaft engages the input sun-gear-shaft (106), while the others engage one of the input selector sun-gear-shafts (108, 110, 112, 114) which are concentrically nested and supported to rotate about a common axis. These selector sun-gear-shafts (108, 110, 112, 114) are freely rotatable until selectively locked to the case by case-mounted braking elements and actuation mechanisms (700).

When one of the input selector sun-gear-shafts (108, 110, 112, or 114) is locked to the case via its case-mounted braking element and actuation mechanism (700), it forms a reaction element. The interaction between the input sun-gear-shaft (106) and the locked selector sun-gear-shaft (108, 110, 112, or 114) causes the planet-gear-shafts to orbit, thereby rotating the carrier (102). The resulting direction and speed of carrier (102) rotation depend on the relative diameters of the input sun-gear-shaft (106) and the locked selector sun-gear-shaft (108, 110, 112, or 114).

The rotating carrier (102) then transmits torque to the output planetary gearset (118). This output gearset (118) includes a second set of output planet-gear-shafts (132), also mounted within the common carrier (102). Each of these planet-gear-shafts (132) carries multiple rigidly affixed toothed gears. One gear on each shaft engages the output sun-gear-shaft (120), and the remaining gears engage one of the output selector sun-gear-shafts (122, 124, 126, 128) which are concentrically nested and supported to rotate about a common axis. These output selector sun-gear-shafts (122, 124, 126, 128) are selectively locked to the case via case-mounted braking elements and actuation mechanisms (700).

Locking one of the output selector sun-gear-shafts (122, 124, 126, 128) provides a reaction element for the output gearset (118). The carrier (102) rotation causes the output planet-gear-shafts to orbit the locked selector sun-gear-shaft (122, 124, 126, or 128), which results in rotation of the output sun-gear-shaft (120). The direction and speed of output rotation are determined by the interaction between the carrier (102) and the locked output selector sun-gear-shaft (122, 124, 126, 128). The planet-gear-shafts (116, 132) are radially supported at both ends by planet shaft end support bearings (136). The carrier support (136) provides mechanical alignment and radial support for the input gearset (104) and output gearset (118) and carrier (102).

During normal operation, exactly two case-mounted braking elements and actuation mechanisms (700) are engaged at any given time—one applied to an input selector sun-gear-shaft (108, 110, 112, or 114) in the input gearset (104), and one applied to an output selector sun-gear-shaft (122, 124, 126, or 128) in the output gearset (118). This pair of selectively locked sun-gear-shafts serves as the active reaction elements that define the gear ratio through the input-to-carrier and carrier-to-output torque path.

As illustrated in FIGS. 1 through 7, the embodiment with four input selector sun-gear-shafts (108, 110, 112, 114) and four output selector sun-gear-shafts (122, 124, 126, 128) enables sixteen discrete gear ratios, as detailed in FIG. 8. Each gear ratio is defined by a unique combination of one braked input selector sun-gear-shaft and one braked output selector sun-gear-shaft, engaged via their respective case-mounted braking elements and actuation mechanisms (700). This 4×4 selector configuration exemplifies the modular two-brake control matrix described throughout this specification.

### Optional Coupling Modes

For clarity, the present invention does not rely on any direct mechanical coupling between the input sun-gear-shaft (106), the output sun-gear-shaft (120), and/or the shared carrier (102) during normal operation. All standard forward and reverse gear ratios are achieved exclusively through internal gear interactions within the shared carrier (102) and the selective engagement of case-mounted braking elements and actuation mechanisms (700)—specifically, exactly one input selector sun-gear-shaft (108, 110, 112, or 114) and exactly one output selector sun-gear-shaft (122, 124, 126, or 128) braked via their respective case-mounted braking elements and actuation mechanisms (700). Optional configurations described herein—such as selectively mechanically coupling the input sun-gear-shaft (106) or output sun-gear-shaft (120) to a selector sun-gear-shaft (108, 110, 112, 114, 122, 124, 126, 128) or to the shared carrier (102)—are included solely to illustrate extended functionality (e.g., reverse operation outside the normal two-brake control scheme or intentional mechanical lock-up). These optional features are not required for normal operation and do not modify the core planetary architecture or the two-brake control matrix that defines gear ratio selection.

### Selector Shaft Routing and Packaging Variants

In some embodiments, the shared carrier (102) is constructed from multiple structural components rigidly joined to function as a single rotating unit. This modular construction enables both the input selector sun-gear-shafts (108, 110, 112, 114) and the output selector sun-gear-shafts (122, 124, 126, 128) to extend in opposing axial directions from their respective planetary gearsets (104, 118)—specifically, both outward toward the axial ends of the transmission assembly and inward toward a central carrier support structure (136).

This bidirectional selector gear layout preserves the core planetary arrangement and the two-brake shift logic while substantially enhancing packaging efficiency. By distributing the selector sun-gear-shafts between the center region and the outer ends of the transmission, this configuration enables a more compact axial form factor and creates additional clearance for optimized placement of case-mounted braking elements and actuation mechanisms (700).

The resulting packaging improvements reduce overall transmission length without impacting torque flow, shift logic, or mechanical simplicity. The use of a multipiece carrier structure allows for precise alignment and mechanical continuity across the entire assembly, ensuring that the dual-direction selector layout integrates seamlessly within the shared carrier (102) architecture.

The invention claimed is:

1. A planetary transmission comprising:
a single, shared carrier configured to rotate about a central axis and to house both an input planetary gearset and an output planetary gearset;
the carrier being formed from one or more structural subassemblies that are rigidly joined to rotate as a single, unified body, such that torque is transmitted through the entire planetary system via a continuous carrier assembly;
the carrier being supported within the transmission housing and not mechanically coupled to either the input or output sun-gear-shafts during any normal operating gear ratio selection mode;
a plurality of planet-gear-shafts mounted within the shared carrier, each planet-gear-shaft supporting a stack of multiple rigidly affixed toothed gears;
an input sun-gear-shaft configured to receive torque from a power source and to drive one or more rigidly affixed toothed gears mounted on the input planet-gear-shafts;
an output sun-gear-shaft configured to transmit torque to a driveline and to receive torque from one or more rigidly affixed toothed gears mounted on the output planet-gear-shafts;
a plurality of input selector sun-gear-shafts and output selector sun-gear-shafts, each concentrically nested and rotatably supported about the central axis relative to the input sun-gear-shaft and the output sun-gear-shaft, respectively;
a plurality of case-mounted brakes, each configured to selectively lock an individual selector sun-gear-shaft to a transmission case;
wherein each input planet-gear-shaft includes at least one rigidly affixed toothed gear that engages the input sun-gear-shaft and at least one rigidly affixed toothed gear that engages an input selector sun-gear-shaft;
wherein each output planet-gear-shaft includes at least one rigidly affixed toothed gear that engages the output sun-gear-shaft and at least one rigidly affixed toothed gear that engages an output selector sun-gear-shaft;
wherein the input and output planetary gearsets are not in direct meshing engagement with one another and operate independently within the shared carrier;
wherein torque transfer from the input sun-gear-shaft to the output sun-gear-shaft occurs through the shared carrier via planet-gear-shaft rotation and orbital motion, without direct mechanical coupling between the input and output sun-gear-shafts;
wherein, during normal operation, a gear ratio is defined exclusively by engagement of exactly one input selector sun-gear-shaft and exactly one output selector sun-gear-shaft via the case-mounted brakes;
wherein, during such normal two-brake operation, engagement of fewer than two selector sun-gear-shafts produces a neutral condition, and engagement of more than two selector sun-gear-shafts produces a mechanical lock-up condition in which all rotating elements are fixed relative to the transmission case;
and wherein underdrive, overdrive, forward, and reverse output rotation relative to the input sun-gear-shaft are selectable based on the relative diameters of the engaged selector sun-gear-shafts and the corresponding sun-gear-shafts.

2. The planetary transmission of claim 1, wherein the input planetary gearset is configured to receive torque from the input sun-gear-shaft and rotate the shared carrier to produce forward overdrive, reverse overdrive, or reverse underdrive of the shared carrier relative to the input sun-gear-shaft rotation direction, depending on which input selector sun-gear-shaft is locked to the case and the relative diameter of that selector sun-gear-shaft to the input sun-gear-shaft.

3. The planetary transmission of claim 1, wherein the output planetary gearset is configured to be driven by the shared carrier, the rotation direction of which is determined by the input planetary gearset, and to rotate the output sun-gear-shaft to produce forward underdrive, reverse underdrive, reverse overdrive, or forward overdrive relative to the rotation direction of the shared carrier, depending on which output selector sun-gear-shaft is locked to the case and the relative diameter of that selector sun-gear-shaft to the output sun-gear-shaft.

4. The planetary transmission of claim 1, wherein each planet-gear-shaft supports a number of rigidly affixed toothed gears equal to the number of selector sun-gear-shafts in its corresponding gearset plus one.

5. The planetary transmission of claim 1, wherein the case-mounted brakes are configured as non-rotating braking elements affixed to the transmission case, actuated by any suitable mechanical, hydraulic, electromechanical, or electrical means.

6. The planetary transmission of claim 1, wherein the shared carrier is not continuously mechanically coupled to either the input sun-gear-shaft or the output sun-gear-shaft, and is rotated as a floating intermediary by orbital motion of the input planet-gear-shafts, which are orbited by the input sun-gear-shaft and react against a locked input selector sun-gear-shaft.

7. The planetary transmission of claim 1, wherein the transmission is configured to provide more than six forward gear ratios using only two brakes engaged at any given time.

8. The planetary transmission of claim 1, wherein each planet-gear-shaft is supported at both ends by bearings or bushings mounted within the shared carrier, such that radial loads resulting from unbalanced gear forces—occurring in embodiments without ring gears—are mechanically reacted through end support bearings or bushings rather than through internal bearings or bushings within the planet-gear-shafts.

9. The planetary transmission of claim 1, wherein, during normal operation, torque flow from the input sun-gear-shaft to the output sun-gear-shaft is mechanically continuous and occurs exclusively through the shared carrier by means of internal gear interactions, without passing through any intermediate clutch, ring gear, or direct mechanical coupling between the input sun-gear-shaft and the output sun-gear-shaft.

10. The planetary transmission of claim 1, wherein the input sun-gear-shaft and the output sun-gear-shaft are each configured as central sun-gear-shafts of their respective planetary gearsets and are both housed within the same shared carrier, the carrier being formed from one or more mechanical subassemblies rigidly joined to rotate as a single, unified structure, such that, during normal operation, torque is transmitted from the input sun-gear-shaft to the output sun-gear-shaft exclusively via internal reactions within the shared carrier.

11. The planetary transmission of claim 1, wherein the input planetary gearset, regardless of internal gearset configuration, is configured to drive the shared carrier through orbital motion of planet-gear-shafts that react against a selectively locked input sun-gear-shaft, and wherein the output planetary gearset is configured to be driven by the shared carrier and to rotate the output sun-gear-shaft through orbital motion of output planet-gear-shafts that react against a selectively locked output sun-gear-shaft, such that carrier rotation and output torque transfer are each defined exclusively by which selector sun-gear-shaft is braked on the corresponding gearset.

12. The planetary transmission of claim 1, wherein vehicle launch is achieved by modulating a brake applied to a selector sun-gear-shaft, in either the input planetary gearset or the output planetary gearset, such that initial torque transfer between the input sun-gear-shaft and the output sun-gear-shaft is effected without a torque converter or rotating input clutch, and wherein said brake is one of the same case-mounted brakes used for gear ratio selection during normal operation.

13. The planetary transmission of claim 1,
wherein a torque-modulating device is optionally disposed between a power source and the input sun-gear-shaft,
the torque-modulating device comprising a torque converter, a friction clutch, a rotating input clutch, an electromechanical coupling, or any other device configured to modulate torque between the power source and the input sun-gear-shaft,
and wherein the presence or absence of said torque-modulating device does not alter the brake-based gear ratio selection logic defined in normal operation.

14. The planetary transmission of claim 1, wherein no ring gears are required for ratio adjustment, reversal, or reaction in any of the torque transfer paths that define gear ratios during normal operation.

15. The planetary transmission of claim 1, wherein one or more ring gears are optionally included in the input or output planetary gearsets, and wherein any such ring gear is selectively braked by a case-mounted brake and functions within the same selector-based torque path logic that defines normal gear ratio selection, such that the ring gear does not serve as a direct torque transfer path between the input sun-gear-shaft and the output sun-gear-shaft independent of the shared carrier.

16. The planetary transmission of claim 1, wherein an optional reverse selector sun-gear-shaft is included within either the input planetary gearset or the output planetary gearset, the reverse selector sun-gear-shaft being dimensioned to produce reverse output rotation when selectively locked to the case as one of the two reaction elements engaged during normal two-brake operation, and wherein said selector sun-gear-shaft is not part of a separate reverse gearset.

17. The planetary transmission of claim 1, wherein reverse gear functionality is optionally achieved by selectively mechanically coupling the input sun-gear-shaft to an input selector sun-gear-shaft or to the shared carrier, and locking a selected output selector sun-gear-shaft to the case, such that reverse output rotation is produced without a separate reverse gearset and outside the normal two-brake control scheme.

18. The planetary transmission of claim 1, wherein reverse gear functionality is optionally achieved by selectively mechanically coupling the output sun-gear-shaft to an output selector sun-gear-shaft or to the shared carrier, and locking a selected input selector sun-gear-shaft to the case, such that reverse output rotation is produced without a separate reverse gearset and outside the normal two-brake control scheme.

19. A method of operating a planetary transmission comprising a shared carrier that houses an input planetary gearset and an output planetary gearset, the method comprising:
(a) actuating exactly one case-mounted brake to lock an input selector sun-gear-shaft to a stationary case;
(b) actuating exactly one case-mounted brake to lock an output selector sun-gear-shaft to the stationary case;
(c) transmitting torque from an input sun-gear-shaft to an output sun-gear-shaft exclusively through the shared carrier by means of orbital motion of planet-gear-shafts;
(d) determining the final gear ratio as a product of an input-to-carrier ratio and a carrier-to-output ratio defined by the selected brake combination;
(e) entering a neutral condition by disengaging both brakes, or a lock-up condition by engaging more than two selector sun-gear-shaft brakes; and
(f) during non-normal operation, selectively mechanically coupling the input sun-gear-shaft or the output sun-gear-shaft to the shared carrier or a selector sun-gear-shaft to define an alternative torque path, including reverse operation, outside the normal two-brake control scheme.

20. The planetary transmission of claim 1,
wherein the shared carrier is constructed from multiple structural subassemblies rigidly joined to rotate as a single mechanical unit,
and wherein the input selector sun-gear-shafts and output selector sun-gear-shafts are arranged to extend in both axial directions from their respective planetary gearsets toward opposite ends of the transmission and inward toward a central carrier support structure,
such that the selector sun-gear-shafts are distributed between the axial ends and the center of the transmission assembly,
thereby enabling improved packaging of case-mounted braking elements and actuation mechanisms without altering the torque transfer path or brake-based gear ratio selection logic.

21. A method of operating a planetary transmission comprising:
(a) locking an input selector sun-gear-shaft to a stationary transmission case using a first case-mounted braking element and actuation mechanism;
(b) locking an output selector sun-gear-shaft to the stationary transmission case using a second case-mounted braking element and actuation mechanism;
(c) transmitting torque from an input sun-gear-shaft to an output sun-gear-shaft exclusively through a shared floating carrier via internal planetary gear interactions; and
(d) transitioning between distinct gear ratios by selectively disengaging one of the case-mounted braking elements and actuation mechanisms and engaging a different case-mounted braking element and actuation mechanism to lock a different selector sun-gear-shaft,
wherein the gear ratio transitions occur with continuous torque delivery and without mechanical coupling between the input sun-gear-shaft and the output sun-gear-shaft.

22. The planetary transmission of claim 1,
wherein the number of available gear ratios equals the product of the number of input selector sun-gear-shafts and the number of output selector sun-gear-shafts,
and wherein each distinct gear ratio is established by engaging exactly one brake on the input and one brake on the output,
such that each unique combination of locked input and output selector sun-gear-shafts defines a different input-to-output gear ratio through the shared floating carrier.

23. The planetary transmission of claim 1, wherein the final output torque is selectively mechanically coupled to either the output sun-gear-shaft or to one of the output selector sun-gear-shafts, such that, in certain configurations, a rotating output selector sun-gear-shaft functions as the primary output shaft by mechanical engagement with a coupling mechanism, the coupling mechanism being configured to selectively disconnect the driveline from the output sun-gear-shaft and connect it to an output selector sun-gear-shaft, and wherein this functional reassignment does not alter the internal torque path through the shared carrier or the two-brake control scheme used for gear ratio selection.
